(19) United States
(12) Patent Application Publication
(10) Pub. No.: US 2015/0139000 A1
(43) Pub. Date: May 21, 2015

(54) ADJUSTMENT OF CQI BASED ON FADING CONDITION

(71) Applicant: QUALCOMM Incorporated, San Diego, CA (US)

(72) Inventors: Sharif Ahsanul Matin, San Diego, CA (US); Jimmy Chi-Wai Chui, Santa Clara, CA (US); Je Woo Kim, Santa Clara, CA (US); Sagar Bharatkumar Shah, San Diego, CA (US); Rajat Sharma, San Diego, CA (US); Aashish Poudel, San Diego, CA (US)

(21) Appl. No.: 14/298,269

(22) Filed: Jun. 6, 2014

Related U.S. Application Data
(60) Provisional application No. 61/905,580, filed on Nov. 18, 2013.

(51) Int. Cl. H04W 24/10

(52) U.S. Cl. CPC H04W 24/10
USPC 370/252

(57) ABSTRACT

CQI is enhanced in fast fading and/or poor RF scenarios. For example, in the event a fast fading condition and/or a poor RF condition is detected at a UE, a CQI value is increased by a defined delta. The UE reports this higher CQI value to a serving access point (e.g., base station) as long as the channel condition prevails this way such that a corresponding increase in throughput may subsequently be seen at the UE.

### CROSS-REFERENCE TO RELATED APPLICATION

This application claims priority to and the benefit of provisional patent application No. 61/905,580 filed in the U.S. patent office on Nov. 18, 2013, the entire content of which is incorporated herein by reference.

### TECHNICAL FIELD

Aspects of the present disclosure relate generally to wireless communication, and more particularly, but not exclusively, to adjusting a channel quality indicator (CQI).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

Some wireless communication networks employ channel quality feedback to maintain a high level of communication performance over a radio frequency (RF) channel. For example, a channel quality indicator (CQI) can be used as an indicative function reflecting the highest data rate at which a wireless device can “reliably” receive via an existing RF channel. In a typical scenario, an access terminal such as a UE generates a CQI estimate based on received downlink signals and transmits a corresponding CQI report to a serving base station such as a Node B. In UMTS, such a CQI report can reflect the performance of a high speed physical downlink shared channel (HS-PDSCH). A Node B can use a received CQI report to select, for example, the transport block size (TBS) to be used for communication with the UE on the downlink. In general, use of a larger TBS results in higher throughput at the UE (assuming the UE can decode the larger TBS).

In practice, it is relatively difficult to properly account for all of the metrics that may influence a CQI. For example, the accuracy of CQI reports may be influenced by many factors, such as one or more of: time selectivity, frequency selectivity of the RF channel, relative geometries of user devices, presence of other user devices, interfering cells, overall HS-PDSCH power controls, or back-off at Node Bs. Therefore, there is a desire to improve CQI reporting in wireless communication networks.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure provide for a CQI enhancement scheme in fast fading conditions and/or poor RF conditions. Under these conditions, CQI reporting is enhanced in a manner that can substantially increase the throughput at a UE. For example, a standard (or base) CQI value can be calculated according to a conventional CQI block error rate (CQI-BLER) algorithm. In the event a fast fading condition and/or a poor RF condition is detected, the standard CQI value is increased by a defined delta. The UE reports this higher CQI value to the serving Node B. The serving Node B may then allocate a larger TBS for downlink communication with the UE as a result of the higher reported CQI. Consequently, a corresponding increase in throughput may be seen at the UE.

In one aspect, the disclosure provides a method for throughput control including receiving a signal; determining that a fading criterion has been met, wherein the determination is based on the received signal; adjusting a channel quality indicator by a defined delta as a result of the determination that the fading criterion has been met; and transmitting the adjusted channel quality indicator.

Another aspect of the disclosure provides an apparatus configured for throughput control. The apparatus including means for receiving a signal; means for determining that a fading criterion has been met, wherein the determination is based on the received signal; means for adjusting a channel quality indicator by a defined delta as a result of the determination that the fading criterion has been met; and means for transmitting the adjusted channel quality indicator.

Another aspect of the disclosure provides an apparatus for throughput control that includes at least one processor and a memory coupled to the at least one processor. The at least one processor is configured to receive a signal; determine that a fading criterion has been met, wherein the determination is based on the received signal; adjust a channel quality indicator by a defined delta as a result of the determination that the fading criterion has been met; and transmit the adjusted channel quality indicator.

Another aspect of the disclosure provides a non-transitory computer-readable medium having instructions for causing a computer to receive a signal; determine that a fading criterion has been met, wherein the determination is based on the received signal; adjust a channel quality indicator by a defined delta as a result of the determination that the fading criterion has been met; and transmit the adjusted channel quality indicator.

Another aspect of the disclosure provides a method for throughput control including receiving a signal indicative of channel quality degradation at an access terminal; determining that a channel quality degradation criterion has been met, wherein the determination is based on the received signal; and adjusting a channel quality indicator by a delta as a result of the determination that the channel quality degradation criterion has been met.

Another aspect of the disclosure provides an apparatus configured for throughput control. The apparatus including means for receiving a signal indicative of channel quality degradation at an access terminal; means for determining that a channel quality degradation criterion has been met, wherein the determination is based on the received signal; and means for adjusting a channel quality indicator by a delta as a result of the determination that the channel quality degradation criterion has been met.

Another aspect of the disclosure provides an apparatus for throughput control that includes at least one processor and a memory coupled to the at least one processor. The at least one processor is configured to receive a signal indicative of channel quality degradation at an access terminal; determine that a channel quality degradation criterion has been met, wherein the determination is based on the received signal; and adjust a channel quality indicator by a delta as a result of the determination that the channel quality degradation criterion has been met.

Another aspect of the disclosure provides a non-transitory computer-readable medium having instructions for causing a computer to receive a signal indicative of channel quality degradation at an access terminal; determine that a channel quality degradation criterion has been met, wherein the determination is based on the received signal; and adjust a channel quality indicator by a delta as a result of the determination that the channel quality degradation criterion has been met.

In one aspect, the disclosure provides a method for throughput control including receiving a signal indicative of a speed at which an access terminal moves; determining that a speed criterion has been met, wherein the determination is based on the received signal; and adjusting a channel quality indicator by a delta as a result of the determination that the speed criterion has been met.

Another aspect of the disclosure provides an apparatus configured for throughput control. The apparatus including means for receiving a signal indicative of a speed at which an access terminal moves; means for determining that a speed criterion has been met, wherein the determination is based on the received signal; and means for adjusting a channel quality indicator by a delta as a result of the determination that the speed criterion has been met.

Another aspect of the disclosure provides an apparatus for throughput control that includes at least one processor and a memory coupled to the at least one processor. The at least one processor is configured to receive a signal indicative of a speed at which an access terminal moves; determine that a speed criterion has been met, wherein the determination is based on the received signal; and adjust a channel quality indicator by a delta as a result of the determination that the speed criterion has been met.

Another aspect of the disclosure provides a non-transitory computer-readable medium having instructions for causing a computer to receive a signal indicative of a speed at which an access terminal moves; determine that a speed criterion has been met, wherein the determination is based on the received signal; and adjust a channel quality indicator by a delta as a result of the determination that the speed criterion has been met.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a conceptual diagram illustrating an example of a network environment in which one or more aspects of the present disclosure may find application.

FIG. 2 is a block diagram illustrating an example of a communication system in which one or more aspects of the disclosure may find application.

FIG. 3 is a conceptual diagram illustrating an example of a radio protocol architecture for a user plane and a control plane.

FIG. 4 is a block diagram illustrating an example of a communication system where a UE is configured to support CQI enhancement in accordance with some aspects of the disclosure.

FIG. 5 is a flowchart illustrating a method of CQI enhancement in accordance with some aspects of the disclosure.

FIG. 6 is a block diagram illustrating select components of an apparatus configured to provide fading-based CQI enhancement in accordance with some aspects of the disclosure.

FIG. 7 is a flowchart illustrating a method of fading-based CQI enhancement in accordance with some aspects of the disclosure.

FIG. 8 is a flowchart illustrating additional aspects of a method of fading-based CQI enhancement in accordance with some aspects of the disclosure.

FIG. 9 is a flowchart illustrating a method of speed-based CQI enhancement in accordance with some aspects of the disclosure.

FIG. 10 is a block diagram illustrating select components of an apparatus configured to provide channel quality degradation-based CQI enhancement in accordance with some aspects of the disclosure.

FIG. 11 is a flowchart illustrating a method of channel quality degradation-based CQI enhancement in accordance with some aspects of the disclosure.

FIG. 12 is a block diagram illustrating a hardware implementation for an apparatus employing a processing system in accordance with some aspects of the disclosure.

FIG. 13 is a block diagram illustrating an example of a base station in communication with an access terminal in a communication network.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

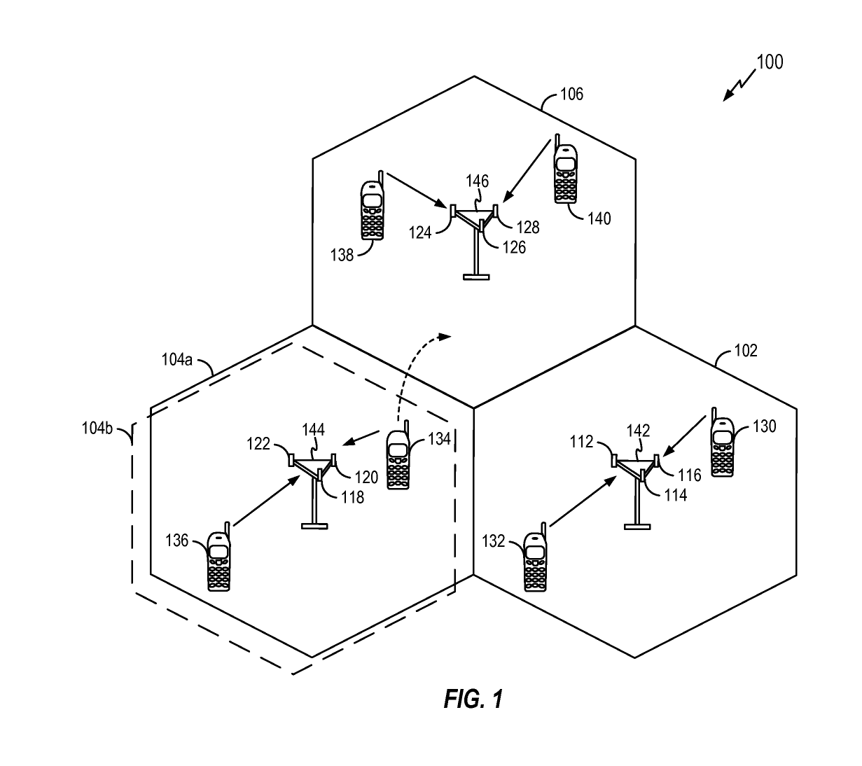

The various concepts presented throughout this disclosure may be implemented across a broad variety of telecommunication systems, network architectures, and communication standards. Referring to FIG. 1, by way of example and without limitation, a simplified access network 100 in a UMTS Terrestrial Radio Access Network (UTRAN) architecture, which may utilize High-Speed Packet Access (HSPA), is illustrated. The system includes multiple cellular regions (cells), including cells 102, 104, and 106, each of which may include one or more sectors. Cells may be defined geographically, e.g., by coverage area, and/or may be defined in accordance with a frequency, scrambling code, etc. That is, the illustrated geographically-defined cells 102, 104, and 106 may each be further divided into a plurality of cells, e.g., by utilizing different frequencies or scrambling codes. For example, cell 104a may utilize a first frequency or scrambling code, and cell 104b, while in the same geographic region and served by the same Node B 144, may be distinguished by utilizing a second frequency or scrambling code.

In a cell that is divided into sectors, the multiple sectors within a cell can be formed by groups of antennas with each antenna responsible for communication with UEs in a portion of the cell. For example, in cell 102, antenna groups 112, 114, and 116 may each correspond to a different sector. In cell 104, antenna groups 118, 120, and 122 each correspond to a different sector. In cell 106, antenna groups 124, 126, and 128 each correspond to a different sector.

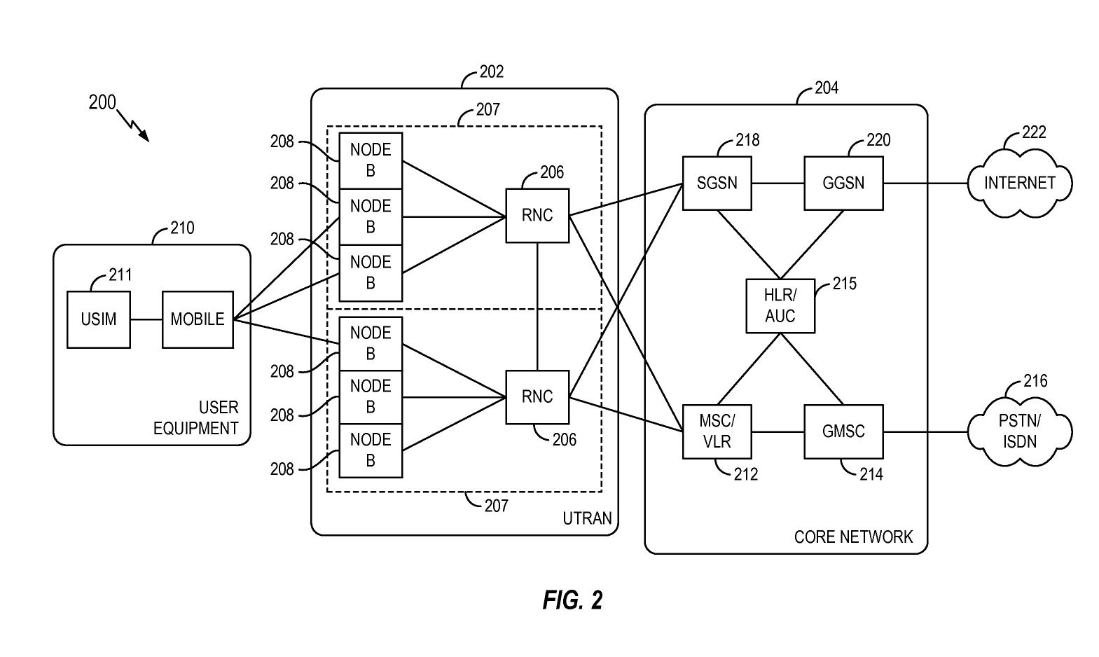

The cells 102, 104 and 106 may include several UEs that may be in communication with one or more sectors of each cell 102, 104 or 106. For example, UEs 130 and 132 may be in communication with Node B 142, UEs 134 and 136 may be in communication with Node B 144, and UEs 138 and 140 may be in communication with Node B 146. Here, each Node B 142, 144, 146 is configured to provide an access point to a core network 204 (see FIG. 2) for all the UEs 130, 132, 134, 136, 138, 140 in the respective cells 102, 104, and 106.

Referring now to FIG. 2, by way of example and without limitation, various aspects of the present disclosure are illustrated with reference to a Universal Mobile Telecommunications System (UMTS) system 200 employing a wideband code division multiple access (W-CDMA) air interface. A UMTS network includes three interacting domains: a Core Network (CN) 204, a UMTS Terrestrial Radio Access Network (UTRAN) 202, and User Equipment (UE) 210. In this example, the UTRAN 202 may provide various wireless services including telephony, video, data, messaging, broadcasts, and/or other services. The UTRAN 202 may include a plurality of Radio Network Subsystems (RNSs) such as the illustrated RNSs 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface.

A high speed packet access (HSPA) air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

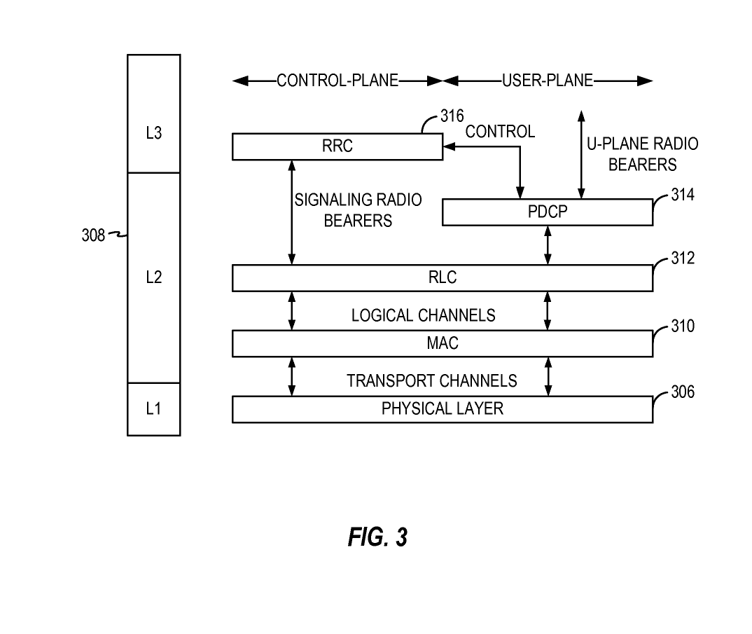

In a wireless telecommunication system, the radio protocol architecture between a mobile device and a cellular network may take on various forms depending on the particular application. An example for a 3GPP high-speed packet access (HSPA) system will now be presented with reference to FIG. 3, illustrating an example of the radio protocol architecture for the user and control planes between the UE 210 and the Node B 208. Here, the user plane or data plane carries user traffic, while the control plane carries control information, i.e., signaling.

Turning to FIG. 3, the radio protocol architecture for the UE 210 and Node B 208 is shown with three layers: Layer 1, Layer 2, and Layer 3. Although not shown, the UE 210 may have several upper layers above the L3 layer including a network layer (e.g., IP layer) that is terminated at a PDN gateway on the network side, and an application layer that is terminated at the other end of the connection (e.g., far end UE, server, etc.).

At Layer 3, the RRC layer 316 handles control plane signaling between the UE 210 and the Node B 208. RRC layer 316 includes a number of functional entities for routing higher layer messages, handling broadcast and paging functions, establishing and configuring radio bearers, etc.

The data link layer, called Layer 2 (L2 layer) 308 is between Layer 3 and the physical layer 306, and is responsible for the link between the UE 210 and Node B 208. In the illustrated air interface, the L2 layer 308 is split into sublayers. In the control plane, the L2 layer 308 includes two sublayers: a medium access control (MAC) sublayer 310 and a radio link control (RLC) sublayer 312. In the user plane, the L2 layer 308 additionally includes a packet data convergence protocol (PDCP) sublayer 314. Of course, those of ordinary skill in the art will comprehend that additional or different sublayers may be utilized in a particular implementation of the L2 layer 308, still within the scope of the present disclosure.

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between Node Bs.

The RLC sublayer 312 provides segmentation and reassembly of upper layer data packets, retransmission of lost data packets, and reordering of data packets to compensate for out-of-order reception due to a hybrid automatic repeat request (HARQ).

The MAC sublayer 310 provides multiplexing between logical channels and transport channels. The MAC sublayer 310 is also responsible for allocating the various radio resources (e.g., resource blocks) in one cell among the UEs. The MAC sublayer 310 is also responsible for HARQ operations.

Layer 1 is the lowest layer and implements various physical layer signal processing functions. Layer 1 will be referred to herein as the physical layer (PHY) 306. At the PHY layer 306, the transport channels are mapped to different physical channels.

Data generated at higher layers, all the way down to the MAC layer 310, are carried over the air through transport channels. 3GPP Release 5 specifications introduced downlink enhancements referred to as HSDPA. HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries HARQ ACK/NACK signaling on the uplink to indicate whether a corresponding packet transmission was decoded successfully. That is, with respect to the downlink, the UE 210 provides feedback to the Node B 208 over the HS-DPCCH to indicate whether it correctly decoded a packet on the downlink.

HS-DPCCH further includes feedback signaling from the UE 210 to assist the Node B 208 in making the right decision in terms of modulation and coding scheme and precoding weight selection; this feedback signaling including the channel quality indicator (CQI) and precoding control information (PCI).

3GPP Release 6 specifications introduced uplink enhancements referred to as Enhanced Uplink (EUL) or High Speed Uplink Packet Access (HSUPA). HSUPA utilizes as its transport channel the EUL Dedicated Channel (E-DCH). The E-DCH is transmitted in the uplink together with the Release 99 DCH. The control portion of the DCH, that is, the DPCCH, carries pilot bits and downlink power control commands on uplink transmissions. In the present disclosure, the DPCCH may be referred to as a control channel (e.g., a primary control channel) or a pilot channel (e.g., a primary pilot channel) in accordance with whether reference is being made to the channel's control aspects or its pilot aspects.

The E-DCH is implemented by physical channels including the E-DCH Dedicated Physical Data Channel (E-DPDCH) and the E-DCH Dedicated Physical Control Channel (E-DPCCH). In addition, HSUPA relies on additional physical channels including the E-DCH HARQ Indicator Channel (E-HICH), the E-DCH Absolute Grant Channel (E-AGCH), and the E-DCH Relative Grant Channel (E-RGCH). Further, in accordance with aspects of the present disclosure, for HSUPA with MIMO utilizing two transmit antennas, the physical channels include a Secondary E-DPDCH (S-E-DPDCH), a Secondary E-DPCCH (S-E-DPCCH), and a Secondary DPCCH (S-DPCCH).

Thus, UMTS networks utilize a channel structure whereby logical channels (e.g., logical control and traffic channels for uplink and downlink traffic) are mapped to transport channels which are, in turn, mapped to the physical channels. Different frame structures, coding, and operating modes may be deployed depending on, for example, the traffic being carried and deployment decisions.

### CQI-BLER Alignment

Networks such as those described above in conjunction with FIGS. 1-3, as well as other types of networks, may use CQI feedback from UEs as a means of determining how to allocate resources (e.g., TBSs) for the downlink. In some networks, CQI reporting is implemented such that a UE experiences approximately 10% BLER across different channels (e.g., for AWGN channel), in most of the geometries seen by the UE. Accordingly, such a CQI reporting scheme may be referred to as being based on CQI-BLER alignment (CBA).

Such an approach may be based on interpretation of the 3GPP Specification 25.214 which recites as follows at sub-clause 6A.2.1: “Based on an unrestricted observation interval, the UE shall report the highest tabulated CQI value for which a single HS-DSCH sub-frame formatted with the transport block size, number of HS-PDSCH codes and modulation corresponding to the reported or lower CQI value could be received with a transport block error probability not exceeding 0.1 in a 3-slot reference period ending 1 slot before the start of the first slot in which the reported CQI value is transmitted.” 3GPP Specification 25.214 v. 11.7 (September 2013).

The same sub-clause of the specification also recites as follows: “For the purpose of CQI reporting, the UE shall assume a total received HS-PDSCH power of P_{HSPDSCH}=P_{CPICH}+Γ+Δ in dB, where the total received power is evenly distributed among the HS-PDSCH codes of the reported CQI value, the measurement power offset Γ is signalled by higher layers and the reference power adjustment Δ is given by Table 7A, 7B, 7C, 7D, 7E, 7F or 7G depending on the UE category.”

Thus, the CQI computation involves several parameters, specifically the 3^{rd} one—Δ, the reference power adjustment, which stands for variations due to UE categories.

In practice, it is relatively difficult to properly account for all of the metrics that may influence CQIs. Consequently, the CQI reported by a UE using a conventional CQI-BLER algorithm might not be accurate. In view of the above, CQI reporting based on a conventional CQI-BLER algorithm may be too conservative particularly at low geometries, and especially with fast fading channels.

As used herein, the term fading refers to attenuation that a signal is subjected to in a communication medium. Thus, a fading channel refers to a channel in which fading occurs. As fading may change over time due to environmental conditions (e.g., interferers and obstructions) and due to other factors (e.g., movement of a UE), the rate with which the fading changes may be characterized as slow fading or fast fading (or characterized in some other manner). Thus, a channel with fast fading (e.g., due to rapidly changing environmental conditions and/or due to a UE moving at a relatively high rate of speed) may be referred to as a fast fading channel.

### CQI Enhancement

The disclosure relates in some aspects to increasing CQI for a faded channel condition and/or a poor geometry condition. By increasing the CQI under such conditions, a UE may yield higher throughput whereby subframe BLER (SBLER) may converge to a higher value than with a conventional CQI-BLER algorithm. For example, in response to an increased CQI reported by a UE, a Node B may allocate additional resources for the UE such that there is an increase in the downlink throughput (e.g., bits per second) at the UE.

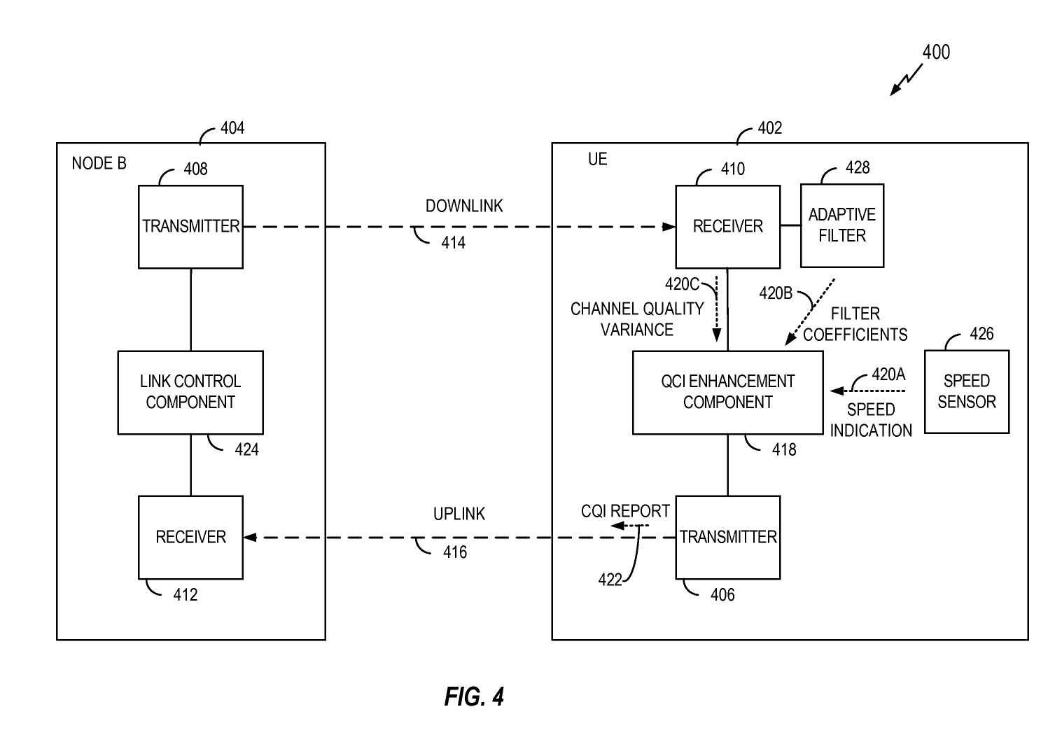

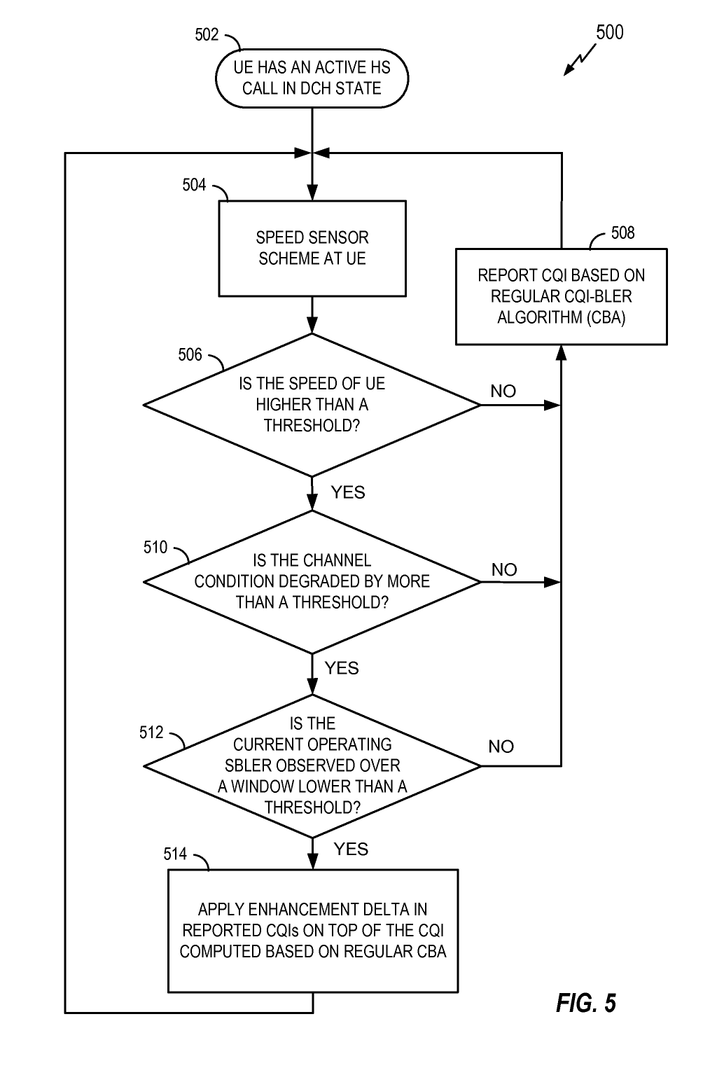

Referring to FIGS. 4 and 5, various aspects of a CQI enhancement scheme according to the present disclosure are presented. For purposes of illustration, and without limitation, these aspects of the disclosure may be described in the context of a UMTS-based network where a Node B serves a user equipment (UE). It should be appreciated that the disclosed aspects may be applicable to other types of apparatuses and other technology. For example, in the UE and Node B context, CQI reporting is typically used as a means to control downlink quality. However, the teachings herein also could be applied to control uplink quality, peer-to-peer link quality, or quality on other types of communication links.

In the communication system 400 of FIG. 4, a UE 402 is served by a Node B 404. The UE 402 and the Node B 404 include respective transmitters 406 and 408 and receivers 410 and 412 for communicating via a downlink 414 and an uplink 416 as indicated.

The UE 402 includes a CQI enhancement component 418 that receives signals indicative of a fast fading condition and/or poor geometry at the UE 402. These signals may be received from the receiver 410 or some other component of the UE 402.

In some implementations, fast fading is detected based on the speed at which the UE moves. In these cases, a speed sensor 426 can generate a speed indication 420A that is provided to the CQI enhancement component 418. For example, the speed sensor 426 can include an accelerometer that detects movement of the UE 402 and estimates the speed at which the UE is moving based on the detected movement. As another example, the speed sensor 426 can include circuitry that receives signal information from several nearby devices (e.g., Node Bs) having known signal timing and uses triangulation or trilateralization to repeatedly detect the location of the UE 402 and, thereby, track the speed at which the UE 402 moves. As yet another example, the speed sensor 426 can include a global positioning system (GPS) receiver that generates an indication of the speed at which the GPS receiver (and, hence, the UE) is moving.

In some implementations, fast fading is detected based on changes in the coefficients used by an adaptive filter 428 (e.g., for the receiver 410). In these cases, the adaptive filter can send filter coefficient information 420B to the CQI enhancement component 418. For example, movement of the UE 402 may affect the signal quality seen on the downlink 414. In an attempt to compensate for such a change in signal quality, the receiver 410 may change the filter coefficients being used to filter received signals. Thus, the rate at which the filter coefficients change can be indicative of the speed at which the UE 402 moves. Conventionally, filter coefficients are chosen based on certain input variables that are generated by sensing the channel dynamics and comparing the resulting estimated values with the real values determined from recent past samples. There can be various metrics a UE may rely on, such as, but not limited to, envelope tracking of automatic gain control (AGC), common pilot channel (CPICH) Ec/Io, Doppler estimations of frequency shift of carrier frequency, etc. A UE commonly uses low pass (LP) filters for such estimations. If the set of coefficients for an LP filter gives relatively more emphasis on most recent samples, the LP filter is for a fast fading (high speed) channel. From a digital signal processing point of view, this means that the pole values are closer to 1. In contrast, if the set of coefficients for an LP filter gives more emphasis on the past samples than recently observed samples, the LP filter is for a slowly varying channel (low speed). The pole values are thus closer to 0, instead of 1 in this case. Accordingly, the coefficients used for such an LP filter can be monitored to obtain a relative estimate of the speed at which a UE is moving.

In some implementations, fast fading is detected based on variations in channel quality (e.g., as measured by the receiver 410). In these cases, the receiver 410 can send channel quality variance information 420C to the CQI enhancement component 418. For example, as noted above, variations in channel quality on the downlink may be indicative of movement of the UE 402. Here, the rate at which the channel quality changes can be indicative of the speed at which the UE 402 moves. In general, the variance of channel quality becomes higher as the UE moves at a higher speed. Thus, the higher the variances, the higher the speed of the UE (e.g., relative to a serving base station such as a Node B). Consequently, a UE can observe the variance of the metric quantifying the channel quality and thereby determine (e.g., estimate) the relative speed at which the UE moves with respect to a base station.

In response to the received signals 420, the CQI enhancement component 418 may increase the current CQI value (e.g., that has been calculated according to the CQI computation described above) by a defined delta. This defined delta is different from the reference power adjustment A specified in the 3GPP Specification sub-clause 25.214 discussed above. This delta may be predefined or dynamically defined.

The UE 402 sends a CQI report 422 including this enhanced CQI value to the serving Node B 404. Upon receiving the CQI report 422, a link control component 424 of the Node B 404 may adjust the downlink resource allocation (e.g., TBSs) for the UE 402 and thereby improve downlink throughput at the UE 402.

According to some aspects of the disclosure, the CQI can be assumed to be an affine function of a Gaussian distribution. An objective function of throughput increment and constraint equations for CQI Range, SBLER, etc., can be formulated and local optimal CQI and SBLER can be sought for the higher throughput under a convex optimization algorithm. A UE can then use those SBLER as an operating point for better throughput.

Accordingly, the disclosure relates in some aspects to a UE increasing CQI by a certain delta to improve throughput whenever fast fading and/or a low geometry channel is sensed by UE.

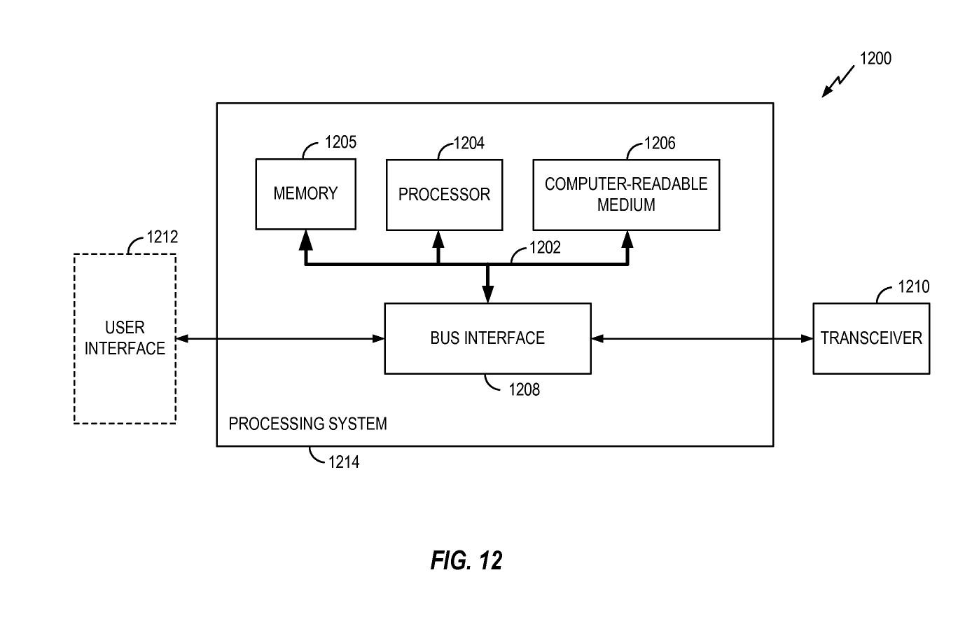

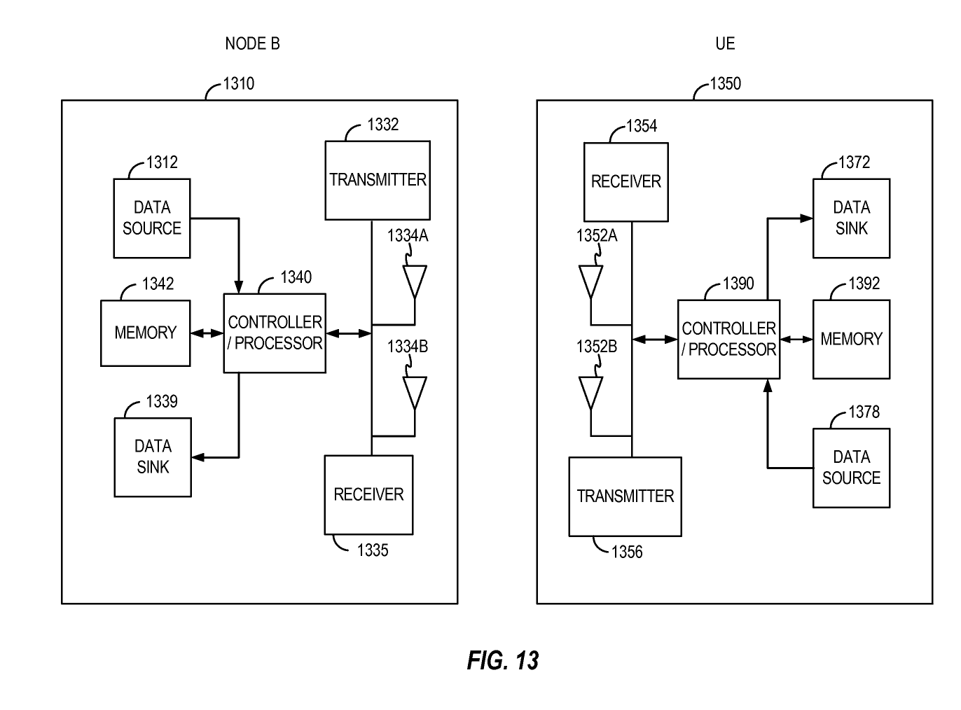

FIG. 5 illustrates a process 500 for CQI enhancement in accordance with some aspects of the present disclosure. The process 500 may take place within the CQI enhancement component 418 of FIG. 4. In another aspect, the process 500 may take place within a processing system 1214 (FIG. 12), which may be located at a UE. In another aspect, the process 500 may be implemented by the UE 1350 illustrated in FIG. 13. Of course, in various aspects within the scope of the present disclosure, the process 500 may be implemented by any suitable apparatus capable of supporting throughput control.

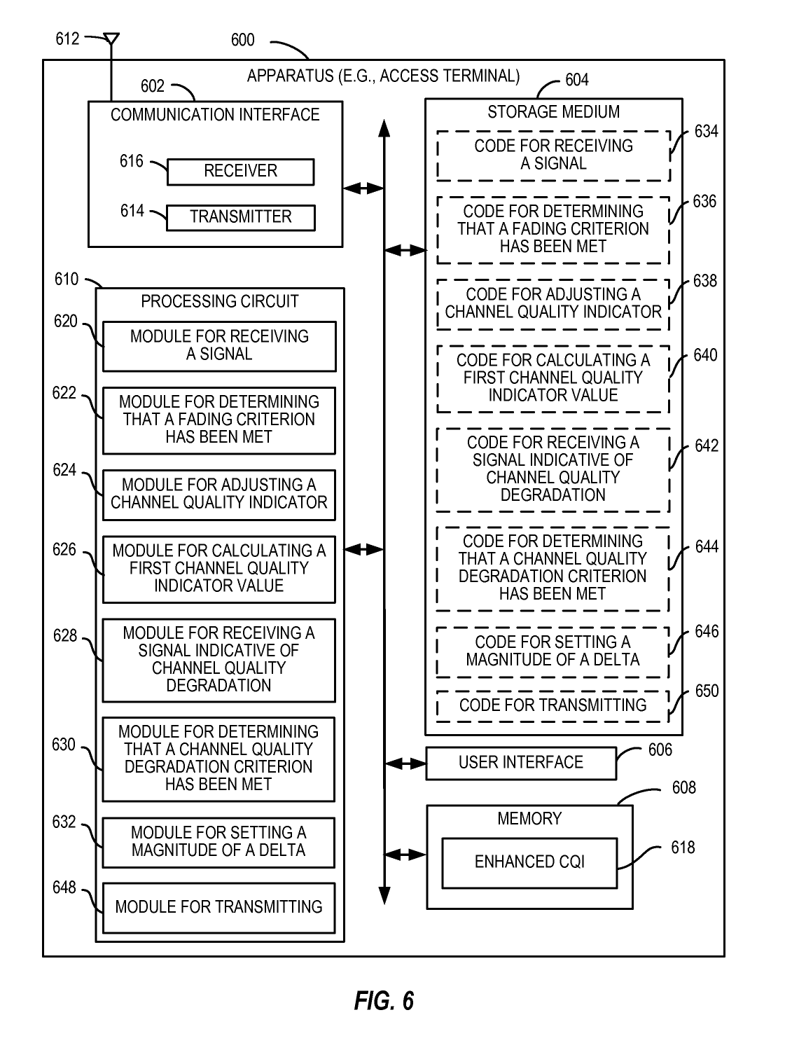

In the example of process 500, the CQI enhancement is invoked when (i) fading speed (detected as a function of the speed at which a UE moves in this example) exceeds a certain threshold and (ii) the channel geometry degrades lower than a certain threshold. As discussed below in conjunction with FIGS. 6-11, in other implementations, CQI enhancement can be invoked when either of these conditions is met.

There are several reasons why CQI enhancement in accordance with the teachings herein may be particularly beneficial under these fading and geometry conditions. Firstly, Node Bs may be more tolerant of high SBLER (fairly commonly, far larger than 10%) in fast fading (e.g., due to rapidly changing environmental conditions or due to a UE moving at a relatively high speed) and low geometries. On the other hand, the physical downlink shared channel (PDSCH) power control may be much stricter for higher geometries (e.g., with cleaner RF) and slow fading channels. Thus, even if a UE tries to amplify CQI under these latter conditions, there might not be much scope at the Node Bs to exercise this. Secondly, even if a Node B allows higher SBLER, there might not be much room for a UE to benefit. This is because of the code rates and transmissions of systematic bits with every retransmission with lower transport block size at low geometries (unlike larger TBS transmitted at cleaner RF), the number of PDSCH codes used, the modulations, etc., associated in a TCP friendly rate control (TFRC) table.

Referring to block 502 of FIG. 5, at some point in time, a UE has an active high speed (HS) call in DCH state.

In block 504, a speed sensor scheme is employed at the UE. The speed at which a UE moves may be detected, for example and without limitation, by a speed sensor at the UE, by analyzing adaptive filter coefficients, by analyzing CQI variance, or through the use of some other suitable technique.

In block 506, a determination is made as to whether the speed at which the UE moves (e.g., the relative speed of the UE with respect to a base station such as a Node B) is higher than a threshold. If not, the process 500 proceeds to block 508 where the UE reports CQIs that are calculated based on a regular (i.e., conventional) CQI-BLER algorithm.

Conversely, if it is determined at block 506 that the speed at which the UE moves is higher than the threshold, the process 500 proceeds to block 510. In block 510, a determination is made as to whether the channel condition has degraded by more than a threshold. Examples of such a degradation in channel condition (e.g., channel quality) include, without limitation, a reduction in received signal quality on a channel, a reduction in received signal strength on a channel, an increase in noise on a channel, or an increase in a packet error rate on a channel. If the channel has not degraded by more than the threshold, the process 500 proceeds to block 508 where the UE reports CQIs that are calculated based on the regular CQI-BLER algorithm.

If it is determined at block 510 that the channel condition has degraded by more than a threshold, the process 500 proceeds to block 512. In block 512, a determination is made as to whether the current operating SBLER observed over a window of time is lower than a threshold. If not, the process 500 proceeds to block 508 where the UE reports CQIs that are calculated based on the regular CQI-BLER algorithm.

Finally, if it is determined at block 512 that the current operating SBLER observed over a window of time is lower than a threshold, the process 500 proceeds to block 514. In block 514, an enhancement delta is applied in reported CQIs on top of the CQI that is computed based on the regular CQI-BLER algorithm. Thus, the reported CQI is increased under fast fading and lower geometry conditions.

FIG. 6 is an illustration of an exemplary apparatus 600 (e.g., an access terminal) configured according to one or more aspects of the present disclosure. The apparatus 600 includes a communication interface (e.g., at least one transceiver) 602, a storage medium 604, a user interface 606, a memory 608, and a processing circuit 610. These components can be coupled to and/or placed in electrical communication with one another via a signaling bus or other suitable component. In particular, each of the communication interface 602, the storage medium 604, the user interface 606, and the memory 608 are coupled to and/or in electrical communication with the processing circuit 610.

The communication interface 602 may be adapted to facilitate wireless communication of the apparatus 600. For example, the communication interface 602 may include circuitry and/or programming adapted to facilitate the communication of information bi-directionally with respect to one or more communication devices in a network. The communication interface 602 may be coupled to one or more antennas 612 for wireless communication within a wireless communication system. The communication interface 602 can be configured with one or more standalone receivers and/or transmitters, as well as one or more transceivers. In the illustrated example, the communication interface 602 includes a transmitter 614 and a receiver 616.

The memory 608 may represent one or more memory devices. As indicated, the memory 608 may store enhanced CQI-related information 618 along with other information used by the apparatus 600. In some implementations, the memory 608 and the storage medium 604 are implemented as a common memory component. The memory 608 may also be used for storing data that is manipulated by the processing circuit 610 or some other component of the apparatus 600.

The storage medium 604 may represent one or more computer-readable, machine-readable, and/or processor-readable devices for storing programming, such as processor executable code or instructions (e.g., software, firmware), electronic data, databases, or other digital information. The storage medium 604 may also be used for storing data that is manipulated by the processing circuit 610 when executing programming. The storage medium 604 may be any available media that can be accessed by a general purpose or special purpose processor, including portable or fixed storage devices, optical storage devices, and various other mediums capable of storing, containing or carrying programming.

By way of example and not limitation, storage medium 604 may comprise a storage device that includes a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, or any other suitable storage device for storing software and/or instructions that may be accessed and read by a computer or a communication device. The storage medium 604 may be embodied in an article of manufacture (e.g., a computer program product). By way of example, a computer program product may include a computer-readable medium in packaging materials. Thus, in some implementations, the storage medium may be a non-transitory (e.g., tangible) storage medium.

The storage medium 604 may be coupled to the processing circuit 610 such that the processing circuit 610 can read information from, and write information to, the storage medium 604. That is, the storage medium 604 can be coupled to the processing circuit 610 so that the storage medium 604 is at least accessible by the processing circuit 610, including examples where at least one storage medium is integral to the processing circuit 610 and/or examples where at least one storage medium is separate from the processing circuit 610 (e.g., resident in the apparatus 600, external to the apparatus 600, distributed across multiple entities).

Programming stored by the storage medium 604, when executed by the processing circuit 610, causes the processing circuit 610 to perform one or more of the various functions and/or process steps described herein. For example, the storage medium 604 may include operations configured for regulating operations at one or more hardware blocks of the processing circuit 610, as well as to utilize the communication interface 602 for wireless communication utilizing their respective communication protocols.

The processing circuit 610 is generally adapted for processing, including the execution of such programming stored on the storage medium 604. As used herein, the term “programming” or the term “code” shall be construed broadly to include without limitation instructions, instruction sets, data, code, code segments, program code, programs, subprograms, software modules, applications, software applications, software packages, routines, subroutines, objects, executables, threads of execution, procedures, functions, programming, etc., whether referred to as software, firmware, middleware, microcode, hardware description language, or otherwise.

The processing circuit 610 is arranged to obtain, process and/or send data, control data access and storage, issue commands, and control other desired operations. The processing circuit 610 may include circuitry configured to implement desired programming provided by appropriate media in at least one example. For example, the processing circuit 610 may be implemented as one or more processors, one or more controllers, and/or other structure configured to execute executable programming. Examples of the processing circuit 610 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 610 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 610 are for illustration and other suitable configurations within the scope of the present disclosure are also contemplated. Also, any of the modules 620-632 and 648 of the processing circuit 610 may be arranged or configured in a similar manner. For example, the modules 620-632 and 648 may be arranged to obtain, process and/or send data, control data access and storage, issue commands, and control other desired operations; may be configured to implement desired programming; may be implemented as appropriate structure configured to execute executable programming; may be implemented as a combination of computing components or other circuitry; and so on.

According to one or more aspects of the present disclosure, the processing circuit 610 may be adapted to perform any or all of the features, processes, functions, steps and/or routines for any or all of the apparatuses described herein. As used herein, the term “adapted” in relation to the processing circuit 610 may refer to the processing circuit 610 being one or more of configured, employed, implemented, and/or programmed to perform a particular process, function, step and/or routine according to various features described herein.

According to at least one example of the apparatus 600, the processing circuit 610 may include a module for receiving a signal 620, a module for determining that a fading criterion has been met 622, a module for adjusting a channel quality indicator 624, a module for calculating a first channel quality indicator value 626, a module for receiving a signal indicative of channel quality degradation 628, a module for determining that a channel quality degradation criterion has been met 630, a module for setting a magnitude of a delta 632, and module for transmitting 648.

The module for receiving a signal 620 may include circuitry and/or programming adapted to perform several functions relating to, for example, receiving information that is indicative of a fading condition. One of these functions involves invoking acquisition of information from another component. For example, the receiver 616 of the apparatus 600 can be configured to monitor for signals from an access point (base station). As another example, the processing circuit 610 of the apparatus 600 can be configured to accept information from a speed sensor or an adaptive filter component (not shown). Another one of these functions involves acquiring the information. For example, the module for receiving a signal 620 in the form of a receiver may decode received signals to derive the information that is encoded in the signals. Another one of these functions involves storing the information for access by another component of the processing circuit 610 or some other component of the apparatus 600. For example, the module for receiving a signal 620 may store the acquired data in a specified memory location in the memory 608. In some implementations, the programming referred to above comprises code for receiving a signal 634 stored on the storage medium 604.

The module for determining that a fading criterion has been met 622 may include circuitry and/or programming adapted to perform several functions relating to, for example, identifying a fading condition based on a received signal. One of these functions involves acquiring fading information. For example, the module for determining that a fading criterion has been met 622 may retrieve this information from the memory 608 (e.g., passed from the receiver 616). Another one of these functions involves comparing the fading condition with at least one criterion. For example, a change in a channel condition (fading) may be compared to a threshold to determine the extent of the fading. Another one of these functions involves storing an indication of the results of the comparison. In some implementations, the programming referred to above comprises code for determining that a fading criterion has been met 636 stored on the storage medium 604.

The module for adjusting a channel quality indicator 624 may include circuitry and/or programming adapted to perform several functions relating to, for example, setting a CQI value based on the results of the determination made by the module for determining that a fading criterion has been met 622. One of these functions involves acquiring an indication of the determination made by the module for determining that a fading criterion has been met 622. For example, the module for adjusting a channel quality indicator 624 may obtain this data from the memory 608. Another one of these functions may involve adding a defined delta to a CQI value. Another one of these functions involves storing the adjusted CQI value. In some implementations, the programming referred to above comprises code for adjusting a channel quality indicator 638 stored on the storage medium 604.

Further, the module for calculating a first channel quality indicator value 626 may include circuitry and/or programming adapted to perform several functions relating to, for example, calculating a CQI value based on channel conditions. One of these functions involves acquiring information regarding channel conditions. For example, the module for calculating a first channel quality indicator value 626 may retrieve this information from the memory 608 or receive this information from the receiver 616. Another one of these functions involves processing the acquired information to calculate a CQI value. For example, a CQI-BLER algorithm as discussed herein may be invoked. Another one of these functions involves outputting the CQI value. For example, the CQI value may be stored in the memory 608. In some implementations, the programming referred to above comprises code for calculating a first channel quality indicator value 640 stored on the storage medium 604.

The module for receiving a signal indicative of channel quality degradation 628 may include circuitry and/or programming adapted to perform several functions relating to, for example, receiving information that is indicative of a channel quality over time. One of these functions involves invoking acquisition of information from another component. For example, the receiver 616 of the apparatus 600 can be configured to monitor for signals from an access point (base station). Another one of these functions involves acquiring the information. For example, the module for receiving a signal indicative of channel quality degradation 628 in the form of a receiver may measure one or more of signal levels, noise levels, or error rate associated with received signals over time to obtain an indication of any changes in signal-to-noise ratio on a channel, packet error rate on a channel, noise on a channel, or some other indication of quality on a channel. Another one of these functions involves storing the information for access by another component of the processing circuit 610 or some other component of the apparatus 600. For example, the module for receiving a signal indicative of channel quality degradation 628 may store the acquired information in a specified memory location in the memory 608. In some implementations, the programming referred to above includes code for receiving a signal indicative of channel quality degradation 642 stored on the storage medium 604.

The module for determining that a channel quality degradation criterion has been met 630 may include circuitry and/or programming adapted to perform several functions relating to, for example, identifying a channel quality degradation condition based on a received signal. One of these functions involves acquiring channel quality information. For example, the module for determining that a channel quality degradation criterion has been met 630 may retrieve this information from the memory 608 (e.g., passed from the module 628). In the event any of the quantities measured by the module 628 changes by a defined amount in a specified direction (e.g., up or down) over a defined period of time or meets a defined threshold, degradation in channel quality may be indicated. Another one of these functions involves comparing the channel quality degradation condition with at least one criterion. For example, degradation of a channel condition may be compared to a threshold to determine the extent of the degradation. Another one of these functions involves storing an indication of the results of the comparison. In some implementations, the programming referred to above comprises code for determining that a channel quality degradation criterion has been met 644 stored on the storage medium 604.

The module for setting a magnitude of a delta 632 may include circuitry and/or programming adapted to perform several functions relating to, for example, dynamically defining a delta to be added to a CQI value. In some implementations, one of these functions involves obtaining information regarding a fading and/or channel quality condition. Another one of these functions involves determining the extent to which the condition exceeds a threshold. Another one of these functions involves selecting a value for the delta based on this extent. Another one of these functions involves storing an indication of the delta (e.g., in the memory 608). In some implementations, the programming referred to above comprises code for setting a magnitude of a delta 646 stored on the storage medium 604.

Finally, the module for transmitting 648 may include circuitry and/or programming adapted to perform several functions relating to, for example, transmitting an adjusted CQI value. In some implementations, one of these functions involves obtaining the adjusted CQI value. Another one of these functions may involve encoding the adjusted CQI value for transmission and/or including the adjusted CQI value in a message or packet. Another one of these functions involves sending the adjusted CQI value, in the appropriate form (e.g., encoded, etc.), to the transmitter 614. In some implementations, the programming referred to above comprises code for transmitting 650 stored on the storage medium 604.

As mentioned above, programming stored by the storage medium 604, when executed by the processing circuit 610, causes the processing circuit 610 to perform one or more of the various functions and/or process steps described herein. For example, the storage medium 604 may include one or more of the code (e.g., operations) for receiving a signal 634, the code for determining that a fading criterion has been met 636, the code for adjusting a channel quality indicator 638, the code for calculating a first channel quality indicator value 640, the code for receiving a signal indicative of channel quality degradation 642, the code for determining that a channel quality degradation criterion has been met 644, the code for setting a magnitude of a delta 646, and the code for transmitting 650.

The processing circuit 610 can thus provide the functionality of the CQI enhancement component 418 of FIG. 4. For example, in some implementations the modules 620, 622, 624, 626, 628, 630, 632, and 648 are the CQI enhancement component 418. As another example, the modules 634, 636, 638, 640, 642, 644, 646, and 650 can be executed to provide the functionality of the CQI enhancement component 418.

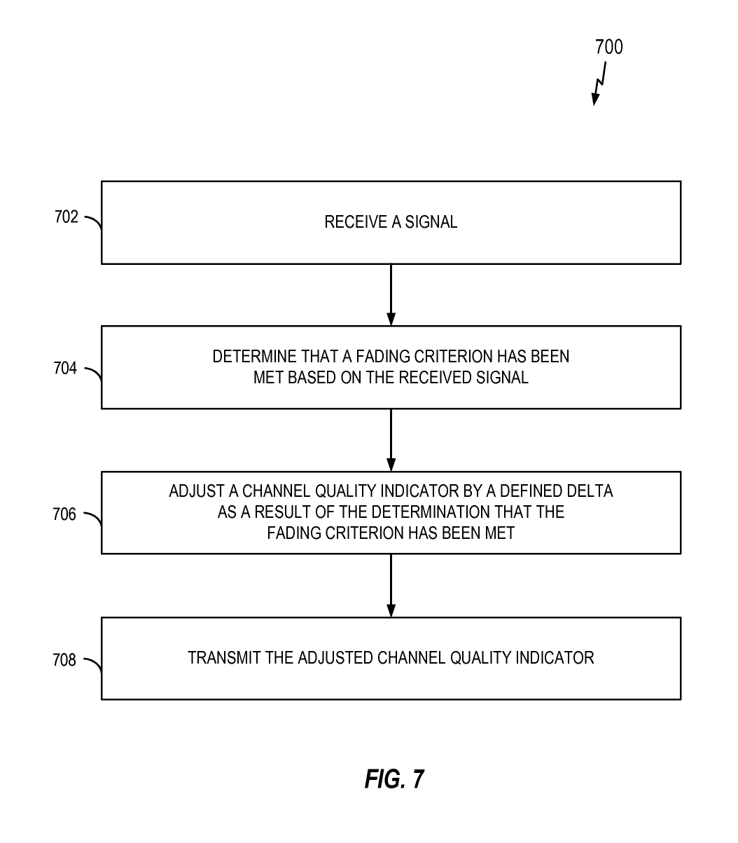

FIG. 7 illustrates a process 700 for CQI enhancement based on a speed criterion in accordance with some aspects of the present disclosure. The process 700 may take place within a processing system 1214 (FIG. 12), which may be located at a UE. In another aspect, the process 700 may be implemented by the UE 1350 illustrated in FIG. 13. Of course, in various aspects within the scope of the present disclosure, the process 700 may be implemented by any suitable apparatus capable of supporting throughput control.

In block 702, a signal is received at an access terminal (e.g., UE). For example, the access terminal may receive a downlink signal. As another example, one component (e.g., a processor) of the access terminal may receive a signal from another component (e.g., a speed sensor) of the access terminal. As yet another example, one component (e.g., a processor) of the access terminal may receive a signal from some other component (e.g., receiver) of the access terminal. In some implementations, the module for receiving a signal 620 of FIG. 6 performs the operations of block 702. In some implementations, the code for receiving a signal 634 of FIG. 6 is executed to perform the operations of block 702.

The received signal may take different forms in different implementations. In some implementations, the received signal is indicative of a fading condition at the access terminal. In some implementations, the received signal is indicative of a relative speed at which the access terminal moves with respect to a base station. In this case, the received signal may be indicative of (e.g., generated by), for example, a speed sensor at the access terminal. In some implementations, the received signal is indicative of adaptive filter coefficients at the access terminal. In some implementations, the received signal is indicative of channel quality variance at the access terminal.

In block 704, a determination is made that a fading criterion has been met. This determination is based, at least in part, on the signal received at block 702. In some implementations, the module for determining that a fading criterion has been met 622 of FIG. 6 performs the operations of block 704. In some implementations, the code for determining that a fading criterion has been met 636 of FIG. 6 is executed to perform the operations of block 704.

As one example, the received signal may be processed to generate an estimate of the fading in a channel. In some implementations, fading is characterized in terms of the signal attenuation seen on a channel. Such attenuation can be represented in dB or some other measure. The resulting fading estimate may then be compared to the fading criterion. A fading criterion may take various forms. For example, and without limitation, a fading criterion may be a fading threshold. In general, the form of the fading criterion will depend on how fading is measured. If fading is measured in terms of the change in attenuation in dB over time, the fading criterion is also specified in terms of a change in dB over time. For example, if the rate at which the fading in dB (e.g., the magnitude of measured signal attenuation in dB) changes over time exceeds a corresponding fast fading threshold (defined in terms of rate of change in attenuation in dB), fast fading on the channel is indicated. Other techniques could be employed to measure fading. For example, changes (variances) of CPICH Ec/Io of the RAKE fingers of a RAKE receiver; estimated signal-to-interference ratio (SIR) of a dedicated channel (e.g., if a UMTS Release R99 channel is used for the call); SIR of the transmit power control (TPC) symbols (e.g., for a call with a fractional dedicated physical channel (F-DPCH)); or the time variance of the CQI itself, etc., can potentially be used to detect fading.

As another example, the received signal may be processed to generate an estimate of the speed at which the access terminal moves (or changes in signal fading due to the speed at which the access terminal moves). The resulting speed may then be compared to a speed criterion.

A speed criterion may take various forms. For example, and without limitation, a speed criterion may be a speed threshold. As another example, and without limitation, a speed criterion may relate to a function of speed over a period time (e.g., an average speed). As yet another example, and without limitation, a speed criterion may relate to a change in speed (e.g., acceleration).

In block 706, a channel quality indicator is adjusted by a defined delta as a result of the determination of block 704. Thus, the channel quality indicator may be increased during a fast fading scenario. In some implementations, the module for adjusting a channel quality indicator 624 of FIG. 6 performs the operations of block 706. In some implementations, the code for adjusting a channel quality indicator 638 of FIG. 6 is executed to perform the operations of block 706.

In block 708, the adjusted channel quality indicator is transmitted. For example, in some implementations, a UE transmits the adjusted channel quality indicator to a Node B. In some implementations, the module for transmitting 648 of FIG. 6 performs the operations of block 708. In some implementations, the code for transmitting 650 of FIG. 6 is executed to perform the operations of block 708.

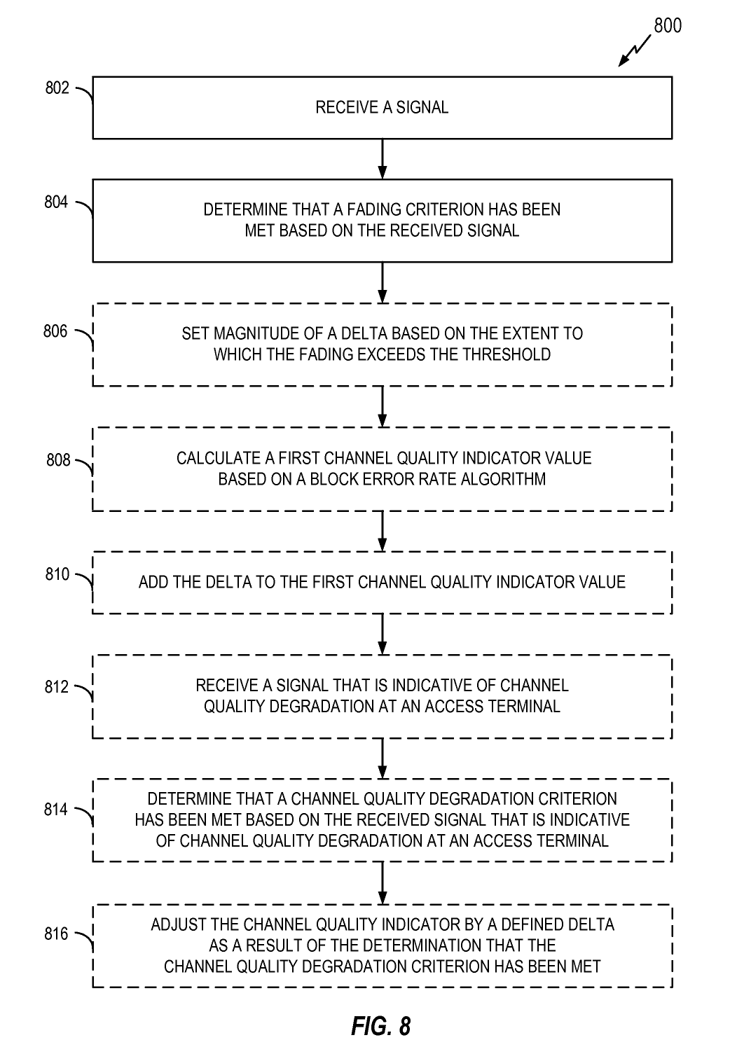

FIG. 8 illustrates a process 800 including additional operations that may be employed in conjunction with the process 700 of FIG. 7 in accordance with some aspects of the present disclosure. For example, in some implementations, the operations of block 806 are employed to define a delta used at block 706 of FIG. 7. In addition, in some implementations, the operations of block 706 of FIG. 7 include the operations of blocks 808 and 810 whereby adjustment of a CQI by a delta involves adding the delta to a BLER-based CQI value. Also, in some implementations, the operations of block 706 of FIG. 7 are modified to also include the operations of blocks 812-816 whereby adjustment of a CQI is also based on whether a channel quality degradation criterion has been met.

The process 800 may take place within a processing system 1214 (FIG. 12), which may be located at a UE. In another aspect, the process 800 may be implemented by the UE 1350 illustrated in FIG. 13. Of course, in various aspects within the scope of the present disclosure, the process 800 may be implemented by any suitable apparatus capable of supporting throughput control.

In block 802, a signal is received (e.g., by a component of an access terminal). The operations of block 802 correspond to the operations of block 702 of FIG. 7.

In block 804, a determination is made that a fading criterion has been met based on the signal received at block 802. The operations of block 804 correspond to the operations of block 704 of FIG. 7.

In some implementations, the value of the delta that is used to adapt a channel quality indicator (e.g., at block 706 of FIG. 7) may be dynamically defined. For example, the determination that the fading criterion has been met may comprise determining an extent to which the fading exceeds a threshold. In this case, in optional block 806, the magnitude of the delta is set based on the extent to which the fading exceeds the threshold. For example, a high-speed fading scenario may result in a larger delta value than a mid-speed fading scenario. As a non-limiting example, a high-speed fading scenario can occur when an access terminal moves at a rate of at least 120 kilometers per hour (km/hr), while a mid-speed fading scenario can occur when an access terminal moves at a rate in the range of 50-120 km/hr. In some implementations, the module for setting a magnitude of a delta 632 of FIG. 6 performs the operations of block 806. In some implementations, the code for setting a magnitude of a delta 646 of FIG. 6 is executed to perform the operations of block 806.

In some implementations, the delta is applied to a channel quality indicator that was calculated using a conventional CQI-BLER algorithm. In such a case, in optional block 808, a first channel quality indicator value is calculated based on a block error rate algorithm. Conventionally, a UE may calculate a CQI-BLER based on an algorithm programmed into the UE. For example, from a certain level of CPICH signal-to-noise ratio (SNR) and Measurement Power Offset (the gain of an HS-PDSCH over a CPICH channel, declared by the network to a UE in an over-the-air (OTA) message), or based on other factors, a UE can determine what kind of CQI should to be reported such that the corresponding Transport Blocks the UE can handle will result in approximately 10% SBLER. This determination is made based on the CQI vs. Transport Block (TrBlk) correspondence table from the 3GPP 25.214 specification discussed above.

In some implementations, the module for calculating a first channel quality indicator value 626 of FIG. 6 performs the operations of block 808. In some implementations, the code for calculating a first channel quality indicator value 640 of FIG. 6 is executed to perform the operations of block 808.

In addition, in optional block 810, the adjustment of the channel quality indicator at block 706 may thus involve adding the delta to the first channel quality indicator value. In some implementations, the module for adjusting a channel quality indicator 624 of FIG. 6 performs the operations of block 810. In some implementations, the code for adjusting a channel quality indicator 638 of FIG. 6 is executed to perform the operations of block 810.

As discussed above in conjunction with FIGS. 4 and 5, in some implementations, adjustment of a channel quality indicator may be based on both the fading seen at the access terminal and channel quality conditions at the access terminal. In such a case, in optional block 812, a signal that is indicative of channel quality degradation at the access terminal is received. In some implementations, the module for receiving a signal indicative of channel quality degradation 628 of FIG. 6 performs the operations of block 812. In some implementations, the code for receiving a signal indicative of channel quality degradation 642 of FIG. 6 is executed to perform the operations of block 812.

In optional block 814, a determination is made that a channel quality degradation criterion has been met based on the signal received at block 812. In some implementations, the module for determining that a channel quality degradation criterion has been met 630 of FIG. 6 performs the operations of block 814. In some implementations, the code for determining that a channel quality degradation criterion has been met 644 of FIG. 6 is executed to perform the operations of block 814.

In addition, in optional block 816, the adjustment of the channel quality indicator is further made as a result of the determination of block 814. In some implementations, the module for adjusting a channel quality indicator 624 of FIG. 6 performs the operations of block 816. In some implementations, the code for adjusting a channel quality indicator 638 of FIG. 6 is executed to perform the operations of block 816.

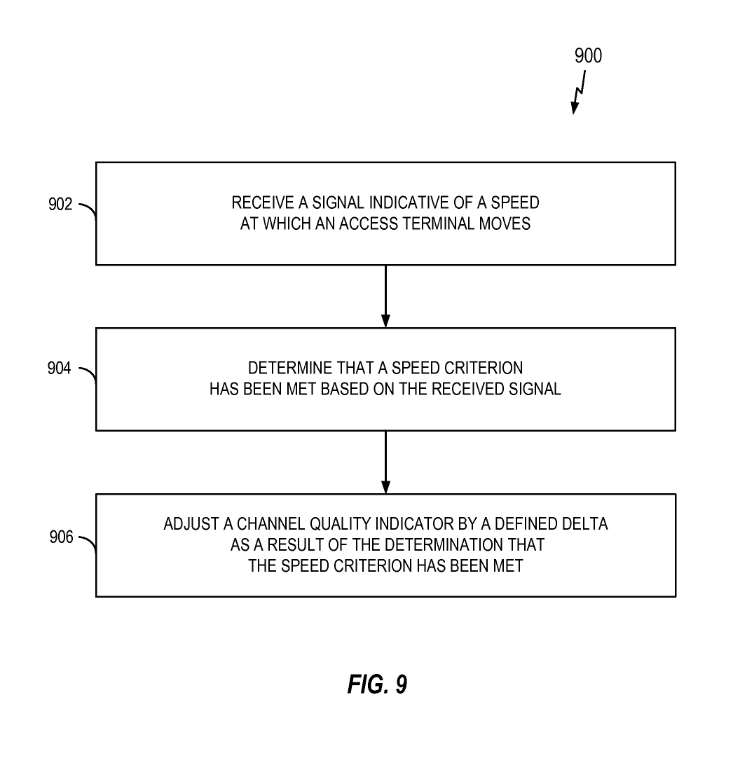

As mentioned above, the fading criterion of FIG. 7 may be based on the speed at which an access terminal moves. FIG. 9 illustrates a process 900 for CQI enhancement based on a speed criterion in accordance with some aspects of the present disclosure. That is, the process 700 of FIG. 7 could take the form of the process 900 in implementations where CQI is adapted based on the speed of the access terminal.

The process 900 may take place within a processing system 1214 (FIG. 12), which may be located at a UE. In another aspect, the process 900 may be implemented by the UE 1350 illustrated in FIG. 13. Of course, in various aspects within the scope of the present disclosure, the process 900 may be implemented by any suitable apparatus capable of supporting throughput control.

In block 902, a signal indicative of a speed at which an access terminal (e.g., UE) moves is received. For example, the access terminal may receive a downlink signal. As another example, a processor of the access terminal may receive a signal from a speed sensor of the access terminal. As yet another example, a processor of the access terminal may receive a signal from a receiver of the access terminal. In some implementations, the module for receiving a signal 620 of FIG. 6 performs the operations of block 902. In some implementations, the code for receiving a signal 634 of FIG. 6 is executed to perform the operations of block 902.

The received signal may take different forms in different implementations. In some implementations, the received signal is indicative of (e.g., generated by) a speed sensor at the access terminal. In some implementations, the received signal is indicative of adaptive filter coefficients at the access terminal. In some implementations, the received signal is indicative of channel quality variance at the access terminal.

In block 904, a determination is made that a speed criterion has been met. This determination is based, at least in part, on the signal received at block 902. For example, the received signal may be processed to generate an estimate of the speed at which the access terminal moves (or changes in signal fading due to the speed of the access terminal). The resulting speed may then be compared to a speed criterion. In some implementations, the module for determining that a fading criterion has been met 622 of FIG. 6 performs the operations of block 904. In some implementations, the code for determining that a fading criterion has been met 636 of FIG. 6 is executed to perform the operations of block 904.

A speed criterion may take various forms. For example, and without limitation, a speed criterion may be a speed threshold. As another example, and without limitation, a speed criterion may relate to a function of speed over a period time (e.g., an average speed). As yet another example, and without limitation, a speed criterion may relate to a change in speed (e.g., acceleration).

In some implementations, the operations of block 904 may involve setting the value of a delta that is used to adapt a channel quality indicator. For example, the determination that the speed criterion has been met may comprise determining an extent to which the relative speed at which the access terminal moves with respect to a base station exceeds a threshold. In this case, the method 900 may further include setting a magnitude of the delta based on the extent to which the speed of the access terminal exceeds the threshold. Thus, a high-speed scenario may result in a larger delta value than a mid-speed scenario.

In block 906, a channel quality indicator is adjusted by a delta as a result of the determination of block 904. In some implementations, the module for adjusting a channel quality indicator 624 of FIG. 6 performs the operations of block 906. In some implementations, the code for adjusting a channel quality indicator 638 of FIG. 6 is executed to perform the operations of block 906.

As a non-limiting example, the channel quality indicator may be increased during a high-speed scenario and, in some cases, during a mid-speed scenario. For example, and without limitation, in some implementations, a mid-speed criterion is set (e.g., 50 km/hr, 60 km/hr, 70 km/hr, or some other speed) such that if this criterion is exceeded, the channel quality indicator is increased by a first delta value (e.g., 0.5 dB, 1 dB, 1.5 dB, or some other delta value). As another example, and without limitation, in some implementations, a high speed criterion is set (e.g., 110 km/hr, 120 km/hr, 130 km/hr, or some other speed) such that if this criterion is exceeded, the channel quality indicator is increased by a second delta value (e.g., 2 dB, 2.5 dB, 3 dB, or some other delta value). In some implementations, multiple criteria and multiple delta values may be used (e.g., a combination of the above).

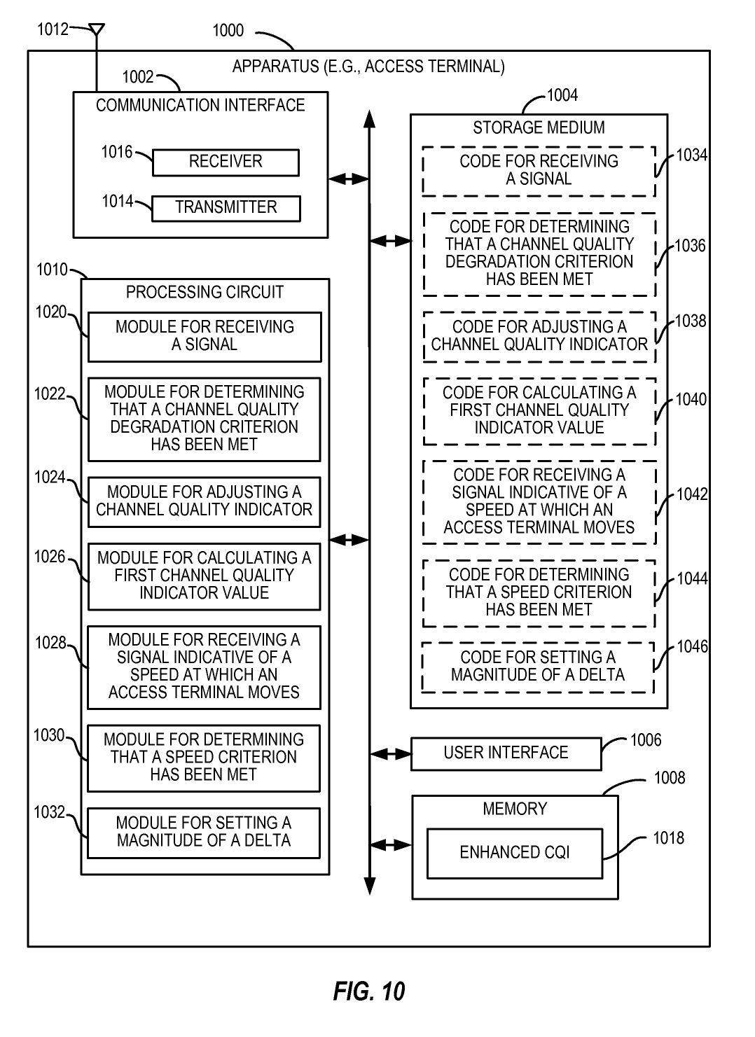

As mentioned above, in some implementations, CQI is adjusted by a delta when channel conditions are poor. FIG. 10 is an illustration of an apparatus 1000 (e.g., an access terminal) configured according to one or more of these aspects of the disclosure. The apparatus 1000 includes a communication interface 1002, a storage medium 1004, a user interface 1006, a memory 1008, and a processing circuit 1010. These components can be coupled to and/or placed in electrical communication with one another via a signaling bus or other suitable component. In particular, each of the communication interface 1002, the storage medium 1004, the user interface 1006, and the memory 1008 are coupled to and/or in electrical communication with the processing circuit 1010.

The communication interface 1002 may be adapted to facilitate wireless communication of the apparatus 1000. For example, the communication interface 1002 may include circuitry and/or programming adapted to facilitate the communication of information bi-directionally with respect to one or more communication devices in a network. The communication interface 1002 may be coupled to one or more antennas 1012 for wireless communication within a wireless communication system. The communication interface 1002 can be configured with one or more standalone receivers and/or transmitters, as well as one or more transceivers. In the illustrated example, the communication interface 1002 includes a transmitter 1014 and a receiver 1016.

The memory 1008 may represent one or more memory devices. As indicated, the memory 1008 may store enhanced CQI-related information 1018 along with other information used by the apparatus 1000. In some implementations, the memory 1008 and the storage medium 1004 are implemented as a common memory component. The memory 1008 may also be used for storing data that is manipulated by the processing circuit 1010 or some other component of the apparatus 1000.

The processing circuit 1010, as well as any of its modules 1020-1032, may be arranged to obtain, process and/or send data, control data access and storage, issue commands, and control other desired operations. The processing circuit 1010, as well as any of its modules 1020-1032, may include circuitry configured to perform a desired function and/or implement desired programming provided by appropriate media. The processing circuit 1010, as well as any of its modules 1020-1032, may be implemented and/or configured according to any of the examples of the processing circuit 610 and modules 620-632 and 648 described above.

According to at least one example of the apparatus 1000, the processing circuit 1010 may include one or more of a module for receiving a signal 1020, a module for determining that a channel quality degradation criterion has been met 1022, a module for adjusting a channel quality indicator 1024, a module for calculating a first channel quality indicator value 1026, a module for receiving a signal indicative of a speed at which an access terminal 1028 moves, a module for determining that a speed criterion has been met 1030, and a module for setting a magnitude of a delta 1032.

The module for receiving a signal 1020 may include circuitry and/or programming adapted to perform several functions relating to, for example, receiving information that is indicative of a channel quality over time. One of these functions involves invoking acquisition of information from another component. For example, the receiver 1016 of the apparatus 1000 can be configured to monitor for signals from an access point (base station). Another one of these functions involves acquiring the information. For example, the module for receiving a signal 1020 in the form of a receiver may measure signal levels and noise levels of received signals. Another one of these functions involves storing the information for access by another component of the processing circuit 1010 or some other component of the apparatus 1000. For example, the module for receiving a signal 1020 may store the acquired information in a specified memory location in the memory 1008. In some implementations, the programming referred to above comprises code for receiving a signal 1034 stored on the storage medium 1004.

The module for determining that a channel quality degradation criterion has been met 1022 may include circuitry and/or programming adapted to perform several functions relating to, for example, identifying a channel quality degradation condition based on a received signal. One of these functions involves acquiring channel quality information. For example, the module for determining that a channel quality degradation criterion has been met 1022 may retrieve this information from the memory 1008 (e.g., passed from the module 1020). Another one of these functions involves comparing the channel quality degradation condition with at least one criterion. For example, degradation of a channel condition may be compared to a threshold to determine the extent of the degradation. Another one of these functions involves storing an indication of the results of the comparison. In some implementations, the programming referred to above comprises code for determining that a channel quality degradation criterion has been met 1036 stored on the storage medium 1004.

The module for adjusting a channel quality indicator 1024 may include circuitry and/or programming adapted to perform several functions relating to, for example, setting a CQI value based on the results of the determination made by the module for determining that a channel quality degradation criterion has been met 1022. One of these functions involves acquiring an indication of the determination made by the module for determining that a channel quality degradation criterion has been met 1022. For example, the module for adjusting a channel quality indicator 1024 may obtain this data from the memory 1008. Another one of these functions may involve adding a defined delta to a CQI value. Another one of these functions involves storing the adjusted CQI value. In some implementations, the programming referred to above comprises code for adjusting a channel quality indicator 1038 stored on the storage medium 1004.

Further, the module for calculating a first channel quality indicator value 1026 may include circuitry and/or programming adapted to perform several functions relating to, for example, calculating a CQI value based on channel conditions. One of these functions involves acquiring information regarding channel conditions. For example, the module for calculating a first channel quality indicator value 1026 may retrieve this information from the memory 1008 or receive this information from the receiver 1016. Another one of these functions involves processing the acquired information to calculate a CQI value. For example, a CQI-BLER algorithm as discussed herein may be invoked. Another one of these functions involves outputting the CQI value. For example, the CQI value may be stored in the memory 1008. In some implementations, the programming referred to above comprises code for calculating a first channel quality indicator value 1040 stored on the storage medium 1004.

The module for receiving a signal indicative of a speed at which an access terminal 1028 moves may include circuitry and/or programming adapted to perform several functions relating to, for example, receiving information that is indicative of a speed condition. One of these functions involves invoking acquisition of information from another component. For example, the processing circuit 1010 of the apparatus 1000 can be configured to accept information from a speed sensor or an adaptive filter component. Another one of these functions involves processing the acquired information (e.g., to generate a speed parameter). Another one of these functions involves storing the information for access by another component of the processing circuit 1010 or some other component of the apparatus 1000. For example, the module for receiving a signal indicative of a speed at which an access terminal moves 1028 may store the acquired information in a specified memory location in the memory 1008. In some implementations, the programming referred to above comprises code for receiving a signal indicative of a speed at which an access terminal moves 1042 stored on the storage medium 1004.

The module for determining that a speed criterion has been met 1030 may include circuitry and/or programming adapted to perform several functions relating to, for example, identifying a speed condition based on a received signal. One of these functions involves acquiring speed information. For example, the module for determining that a speed criterion has been met 1030 may retrieve this information from the memory 1008. Another one of these functions involves comparing the speed condition with at least one criterion. For example, the current speed may be compared to a threshold. Another one of these functions involves storing an indication of the results of the comparison. In some implementations, the programming referred to above comprises code for determining that a speed criterion has been met 1044 stored on the storage medium 1004.

Finally, the module for setting a magnitude of a delta 1032 may include circuitry and/or programming adapted to perform several functions relating to, for example, dynamically defining a delta to be added to a CQI value. In some implementations, one of these functions involves obtaining information regarding a fading and/or channel quality condition. Another one of these functions involves determining the extent to which the condition exceeds a threshold. Another one of these functions involves selecting a value for the delta based on this extent. Another one of these functions involves storing an indication of the delta (e.g., in the memory 1008). In some implementations, the programming referred to above comprises code for setting a magnitude of a delta 1046 stored on the storage medium 1004.

The storage medium 1004 may represent one or more processor-readable devices for storing programming, such as processor executable code or instructions (e.g., software, firmware), electronic data, databases, or other digital information. The storage medium 1004 may be configured and/or implemented in a manner similar to the storage medium 604 described above.

The storage medium 1004 may be coupled to the processing circuit 1010 such that the processing circuit 1010 can read information from, and write information to, the storage medium 1004. That is, the storage medium 1004 can be coupled to the processing circuit 1010 so that the storage medium 1004 is at least accessible by the processing circuit 1010, including examples where the storage medium 1004 is integral to the processing circuit 1010 and/or examples where the storage medium 1004 is separate from the processing circuit 1010.

Like the storage medium 604, the storage medium 1004 includes programming stored thereon. The programming stored by the storage medium 1004, when executed by the processing circuit 1010, causes the processing circuit 1010 to perform one or more of the various decoding functions and/or process steps described herein. For example, the storage medium 1004 may include one or more of the code (e.g., operations) for receiving a signal 1034, the code for determining that a channel quality degradation criterion has been met 1036, the code for adjusting a channel quality indicator 1038, the code for calculating a first channel quality indicator value 1040, the code for receiving a signal indicative of a speed at which an access terminal moves 1042, the code for determining that a speed criterion has been met 1044, and the code for setting a magnitude of a delta 1046.

Thus, according to one or more aspects of the present disclosure, the processing circuit 1010 is adapted to perform (in conjunction with the storage medium 1004) any or all of the decoding processes, functions, steps and/or routines for any or all of the apparatuses described herein. As used herein, the term “adapted” in relation to the processing circuit 1010 may refer to the processing circuit 1010 being one or more of configured, employed, implemented, and/or programmed (in conjunction with the storage medium 1004) to perform a particular process, function, step and/or routine according to various features described herein.

The processing circuit 1010 can thus provide the functionality of the CQI enhancement component 418 of FIG. 4. For example, in some implementations, the modules 1020, 1022, 1024, 1026, 1028, 1030, and 1032 are the CQI enhancement component 418. As another example, the modules 1034, 1036, 1038, 1040, 1042, 1044, and 1046 can be executed to provide the functionality of the CQI enhancement component 418.

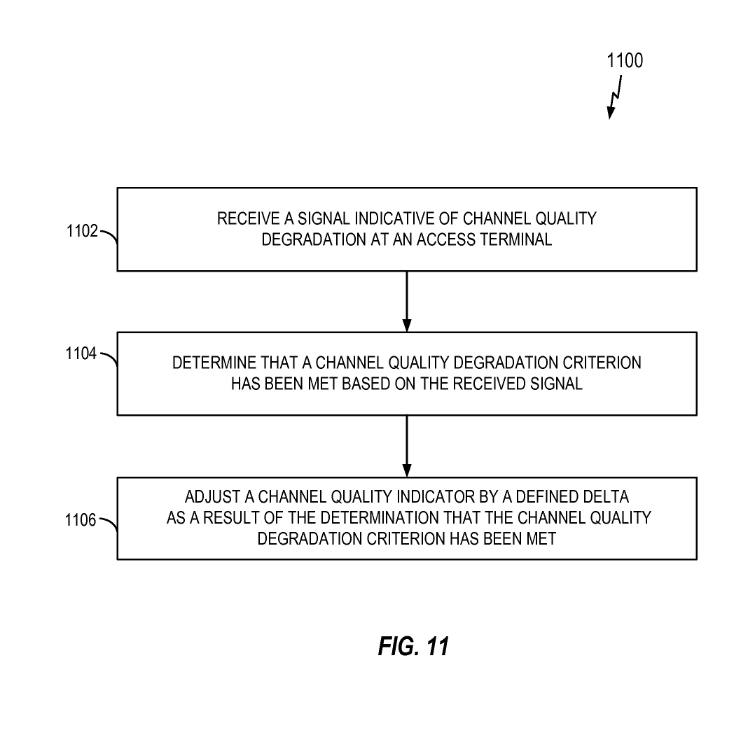

FIG. 11 illustrates a process 1100 for CQI enhancement based on a channel quality degradation criterion in accordance with some aspects of the present disclosure. The process 1100 may take place within a processing system 1214 (FIG. 12), which may be located at a UE. In another aspect, the process 1100 may be implemented by the UE 1350 illustrated in FIG. 13. Of course, in various aspects within the scope of the present disclosure, the process 1100 may be implemented by any suitable apparatus capable of supporting throughput control.

In block 1102, a signal indicative of channel quality degradation at an access terminal is received. For example, the access terminal may receive a downlink signal. As another example, one component (e.g., a processor) of the access terminal may receive a signal from another component (e.g., receiver) of the access terminal. In some implementations, the module for receiving a signal 1020 of FIG. 10 performs the operations of block 1102. In some implementations, the code for receiving a signal 1034 of FIG. 10 is executed to perform the operations of block 1102.

The received signal may take different forms in different implementations. In some implementations, the received signal is indicative of channel quality indicator values associated with downlink signals at the access terminal. In some implementations, the received signal is indicative of common pilot channel (CPICH) Echo associated with downlink signals at the access terminal.

In block 1104, a determination is made that a channel quality degradation criterion has been met. This determination is based, at least in part, on the signal received at block 1102. For example, the received signal may be processed to generate an estimate of the current channel quality. This current channel quality may then be compared to a previously measured channel quality to determine whether the channel quality is deteriorating. The resulting channel quality degradation, if present, may then be compared to a channel quality degradation criterion. In some implementations, the module for determining that a channel quality degradation criterion has been met 1022 of FIG. 10 performs the operations of block 1104. In some implementations, the code for determining that a channel quality degradation criterion has been met 1036 of FIG. 10 is executed to perform the operations of block 1104.

A channel quality degradation criterion may take various forms. For example, and without limitation, a channel quality degradation criterion may be a channel quality degradation threshold. As another example, and without limitation, a channel quality degradation criterion may relate to a function of channel quality over a period time (e.g., a trend in channel quality degradation). As yet another example, and without limitation, a channel quality degradation criterion may relate to a change in channel quality degradation (e.g., a rate of change).

In some implementations, the operations of block 1104 may involve setting the value of a delta that is used to adapt a channel quality indicator. For example, the determination that the channel quality degradation criterion has been met may comprise determining an extent to which the channel quality degradation exceeds a threshold. In this case, the method 1100 may further include setting a magnitude of the delta based on the extent to which the channel quality degradation exceeds the threshold. Thus, a very poor geometry scenario may result in a larger delta value than a poor geometry scenario. In some implementations, the module for setting a magnitude of a delta 1032 of FIG. 10 performs these operations. In some implementations, the code for setting a magnitude of a delta 1046 of FIG. 10 is executed to perform these operations.

In some implementations, the value of a delta is set based on current operating CQI. For example, the extent to which CQI may be increased may be determined by reference to a CQI TBS table, or to the TBS information referenced in 3GPP 25.321.

In block 1106, a channel quality indicator is adjusted by a delta as a result of the determination of block 1104. In some implementations, the module for adjusting a channel quality indicator 1024 of FIG. 10 performs the operations of block 1106. In some implementations, the code for adjusting a channel quality indicator 1038 of FIG. 10 is executed to perform the operations of block 1106.

The channel quality indicator may be increased during a very poor geometry scenario and, in some cases, during a poor geometry scenario. For example, and without limitation, in some implementations, a first poor geometry criterion is set (e.g., Ior/Ioc of 2.5 dB, 3 dB, 3.5 dB, or some other value) such that if the signal quality falls below this criterion, the channel quality indicator is increased by a first delta value (e.g., 0.5 dB, 1 dB, 1.5 dB, or some other delta value). As another example, and without limitation, in some implementations, a second poor geometry criterion is set (e.g., Ior/Ioc of 1 dB, 1.5 dB, 2 dB, or some other value) such that if the signal quality falls below this criterion, the channel quality indicator is increased by a second delta value (e.g., 2 dB, 2.5 dB, 3 dB, or some other delta value). In some implementations, multiple criteria and multiple delta values may be used (e.g., a combination of the above).

The adjustment of the channel quality indicator at block 1106 may involve adding the delta to a first channel quality indicator value. In some implementations, the delta is applied to a channel quality indicator that was calculated using a conventional CQI-BLER algorithm. For example, in such a case, the process 1100 may involve calculating a first channel quality indicator value based on a block error rate algorithm. In some implementations, the module for calculating a first channel quality indicator value 1026 of FIG. 10 performs these operations. In some implementations, the code for calculating a first channel quality indicator value 1040 of FIG. 10 is executed to perform these operations.

As discussed above, in some implementations, adjustment of a CQI is based on both the speed at which the access terminal moves and channel quality conditions at the access terminal. In such a case, the process 1100 may further include receiving a signal indicative of a speed at which the access terminal moves. In some implementations, the module for receiving a signal indicative of a speed at which the access terminal moves 1028 of FIG. 10 performs these operations. In some implementations, the code for receiving a signal indicative of a speed at which the access terminal moves 1042 of FIG. 10 is executed to perform these operations.

The process 1100 also may involve determining that a speed criterion has been met in this case. The determination that a speed criterion has been met may be based on the received signal indicative of the speed at which the access terminal moves. In addition, the adjustment of the channel quality indicator may further be made as a result of the determination that the speed criterion has been met. In some implementations, the module for determining that a speed criterion has been met 1030 of FIG. 10 performs these operations. In some implementations, the code for determining that a speed criterion has been met 1044 of FIG. 10 is executed to perform these operations.

FIG. 12 is a block diagram illustrating an example of a hardware implementation for an apparatus 1200 employing a processing system 1214 that can implement one or more aspects of the disclosure. In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits including one or more processors, represented generally by the processor 1204, a memory 1205, and computer-readable media, represented generally by the computer-readable medium 1206. The bus 1202 may also link various other circuits such as timing sources, peripherals, voltage regulators, and power management circuits, which are well known in the art, and therefore, will not be described any further. A bus interface 1208 provides an interface between the bus 1202 and a transceiver 1210. The transceiver 1210 provides a means for communicating with various other apparatus over a transmission medium. Depending upon the nature of the apparatus, a user interface 1212 (e.g., keypad, display, speaker, microphone, joystick) may also be provided.

The processor 1204 is responsible for managing the bus 1202 and general processing, including the execution of software stored on the computer-readable medium 1206. The software, when executed by the processor 1204, causes the processing system 1214 to perform the various functions described infra for any particular apparatus. The computer-readable medium 1206 may also be used for storing data that is manipulated by the processor 1204 when executing software.

FIG. 13 is a block diagram of an exemplary Node B 1310 in communication with an exemplary UE 1350, where the Node B 1310 may be the Node B 208 in FIG. 2, and the UE 1350 may be the UE 210 in FIG. 2. In the downlink communication, a controller or processor 1340 may receive data from a data source 1312. Channel estimates may be used by a controller/processor 1340 to determine the coding, modulation, spreading, and/or scrambling schemes for the transmit processor 1320. These channel estimates may be derived from a reference signal transmitted by the UE 1350 or from feedback from the UE 1350. A transmitter 1332 may provide various signal conditioning functions including amplifying, filtering, and modulating frames onto a carrier for downlink transmission over a wireless medium through one or more antennas 1334. The antennas 1334 may include one or more antennas, for example, including beam steering bidirectional adaptive antenna arrays, MIMO arrays, or any other suitable transmission/reception technologies.

At the UE 1350, a receiver 1354 receives the downlink transmission through one or more antennas 1352 and processes the transmission to recover the information modulated onto the carrier. The information recovered by the receiver 1354 is provided to a controller/processor 1390. The processor 1390 descrambles and despreads the symbols, and determines the most likely signal constellation points transmitted by the Node B 1310 based on the modulation scheme. These soft decisions may be based on channel estimates computed by the processor 1390. The soft decisions are then decoded and deinterleaved to recover the data, control, and reference signals. The CRC codes are then checked to determine whether the frames were successfully decoded. The data carried by the successfully decoded frames will then be provided to a data sink 1372, which represents applications running in the UE 1350 and/or various user interfaces (e.g., display). Control signals carried by successfully decoded frames will be provided to a controller/processor 1390. When frames are unsuccessfully decoded, the controller/processor 1390 may also use an acknowledgement (ACK) and/or negative acknowledgement (NACK) protocol to support retransmission requests for those frames.

In the uplink, data from a data source 1378 and control signals from the controller/processor 1390 are provided. The data source 1378 may represent applications running in the UE 1350 and various user interfaces (e.g., keyboard). Similar to the functionality described in connection with the downlink transmission by the Node B 1310, the processor 1390 provides various signal processing functions including CRC codes, coding and interleaving to facilitate FEC, mapping to signal constellations, spreading with OVSFs, and scrambling to produce a series of symbols. Channel estimates, derived by the processor 1390 from a reference signal transmitted by the Node B 1310 or from feedback contained in a midamble transmitted by the Node B 1310, may be used to select the appropriate coding, modulation, spreading, and/or scrambling schemes. The symbols produced by the processor 1390 will be utilized to create a frame structure. The processor 1390 creates this frame structure by multiplexing the symbols with additional information, resulting in a series of frames. The frames are then provided to a transmitter 1356, which provides various signal conditioning functions including amplification, filtering, and modulating the frames onto a carrier for uplink transmission over the wireless medium through the one or more antennas 1352.

The uplink transmission is processed at the Node B 1310 in a manner similar to that described in connection with the receiver function at the UE 1350. A receiver 1335 receives the uplink transmission through the one or more antennas 1334 and processes the transmission to recover the information modulated onto the carrier. The information recovered by the receiver 1335 is provided to the processor 1340, which parses each frame. The processor 1340 performs the inverse of the processing performed by the processor 1390 in the UE 1350. The data and control signals carried by the successfully decoded frames may then be provided to a data sink 1339. If some of the frames were unsuccessfully decoded by the receive processor, the controller/processor 1340 may also use an acknowledgement (ACK) and/or negative acknowledgement (NACK) protocol to support retransmission requests for those frames.

The controller/processors 1340 and 1390 may be used to direct the operation at the Node B 1310 and the UE 1350, respectively. For example, the controller/processors 1340 and 1390 may provide various functions including timing, peripheral interfaces, voltage regulation, power management, and other control functions. The computer readable media of memories 1342 and 1392 may store data and software for the Node B 1310 and the UE 1350, respectively.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for throughput control, comprising:
receiving a signal;
determining that a fading criterion has been met, wherein the determination is based on the received signal;
adjusting a channel quality indicator by a defined delta as a result of the determination that the fading criterion has been met; and
transmitting the adjusted channel quality indicator.

2. The method of claim 1, wherein the determination that the fading criterion has been met comprises detecting a fast fading channel.

3. The method of claim 1, wherein:
the signal is indicative of a relative speed at which an access terminal moves with respect to a base station; and
the determination that the fading criterion has been met comprises determining that the relative speed at which the access terminal moves with respect to the base station exceeds a threshold.

4. The method of claim 3, wherein the received signal is indicative of a speed sensor at the access terminal.

5. The method of claim 1, wherein the received signal is indicative of adaptive filter coefficients at an access terminal.

6. The method of claim 1, wherein the received signal is indicative of channel quality variance at an access terminal.

7. The method of claim 1, wherein:
the adjustment of the channel quality indicator comprises adding the delta to a first channel quality indicator value; and
the method further comprises calculating the first channel quality indicator value based on a block error rate algorithm.

8. The method of claim 1, further comprising:
receiving a signal indicative of channel quality degradation at an access terminal; and
determining that a channel quality degradation criterion has been met, wherein the determination that the channel quality degradation criterion has been met is based on the received signal indicative of channel quality degradation at the access terminal, and wherein the adjustment of the channel quality indicator is further a result of the determination that the channel quality degradation criterion has been met.

9. The method of claim 8, wherein the determination that the channel quality degradation criterion has been met comprises determining that the channel quality degradation exceeds a threshold.

10. The method of claim 8, wherein the received signal indicative of channel quality degradation at the access terminal indicates common pilot channel (CPICH) Echo associated with downlink signals at the access terminal.

11. An apparatus for throughput control, comprising:
at least one processor; and
a memory coupled to the at least one processor,
wherein the at least one processor is configured to:
receive a signal;
determine that a fading criterion has been met, wherein the determination is based on the received signal;
adjust a channel quality indicator by a defined delta as a result of the determination that the fading criterion has been met; and
transmit the adjusted channel quality indicator.

12. The apparatus of claim 11, wherein the determination that the fading criterion has been met comprises detecting a fast fading channel.

13. The apparatus of claim 11, wherein:
the signal is indicative of a relative speed at which an access terminal moves with respect to a base station; and
the determination that the fading criterion has been met comprises determining that the relative speed at which the access terminal moves with respect to the base station exceeds a threshold.

14. The apparatus of claim 13, wherein the received signal is indicative of a speed sensor at the access terminal.

15. The apparatus of claim 11, wherein the received signal is indicative of adaptive filter coefficients at an access terminal.

16. The apparatus of claim 11, wherein the received signal is indicative of channel quality variance at an access terminal.

17. The apparatus of claim 11, wherein:
the adjustment of the channel quality indicator comprises adding the delta to a first channel quality indicator value; and
the at least one processor is further configured to calculate the first channel quality indicator value based on a block error rate algorithm.

18. The apparatus of claim 11, wherein the at least one processor is further configured to:
receive a signal indicative of channel quality degradation at an access terminal; and
determine that a channel quality degradation criterion has been met, wherein the determination that the channel quality degradation criterion has been met is based on the received signal indicative of channel quality degradation at the access terminal, and wherein the adjustment of the channel quality indicator is further a result of the determination that the channel quality degradation criterion has been met.

19. The apparatus of claim 18, wherein the determination that the channel quality degradation criterion has been met comprises determining that the channel quality degradation exceeds a threshold.

20. A non-transitory computer-readable medium comprising instructions for causing a computer to:
receive a signal;
determine that a fading criterion has been met, wherein the determination is based on the received signal;
adjust a channel quality indicator by a defined delta as a result of the determination that the fading criterion has been met; and
transmit the adjusted channel quality indicator.
